(19) United States
(12) Patent Application Publication
(10) Pub. No.: US 2015/0093250 A1
(43) Pub. Date: Apr. 2, 2015

(54) ROOT STIFFENER ASSEMBLY FOR A WIND TURBINE ROTOR BLADE

(71) Applicant: General Electric Company, Schenectady, NY (US)

(72) Inventors: Bruce Clark Busbey, Greenville, SC (US); Darren John Danielsen, Glenville, NY (US)

(73) Assignee: General Electric Company, Schenectady, NY (US)

(21) Appl. No.: 14/041,041

(22) Filed: Sep. 30, 2013

(51) Int. Cl. F03D 1/06; F03D 1/00

(52) U.S. Cl. CPC F03D 1/0675; F03D 1/001
USPC 416/241 R; 29/889.71

(57) ABSTRACT

In one aspect, a rotor blade for a wind turbine may include a body extending between a root end and a tip end. The body may include a root portion extending from the root end. The root portion may include an inner surface defining an inner circumference. In addition, the rotor blade may include a root stiffener assembly disposed within the root portion of the body. The root stiffener assembly may include a plurality of stiffening ribs coupled to the root portion so as to extend along the inner surface. The stiffening ribs may be spaced apart from one another circumferentially around the inner circumference of the root portion

### FIELD OF THE INVENTION

The present subject matter relates generally to wind turbines and, more particularly, to a root stiffener assembly for stiffening the root portion of a wind turbine rotor blade.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy from wind using known airfoil principles and transmit the kinetic energy through rotational energy to turn a shaft coupling the rotor blades to a gearbox, or if a gearbox is not used, directly to the generator. The generator then converts the mechanical energy to electrical energy that may be deployed to a utility grid.

To ensure that wind power remains a viable energy source, efforts have been made to increase energy outputs by modifying the size and capacity of wind turbines. One such modification has been to increase the length of the rotor blades. However, as is generally understood, the loading on a rotor blade is a function of blade length, along with wind speed and turbine operating states. Thus, longer rotor blades may be subject to increased loading, particularly when a wind turbine is operating in high-speed wind conditions.

During the operation of a wind turbine, the loads acting on a rotor blade are transmitted through the blade and into the blade root or root portion of the blade. Thus, as rotor blades are lengthened and the loads acting on such blades increase, there is an increased likelihood that the resulting loads may cause ovalization or out-of-roundness of the root portion. Such ovalization of the root portion may result in an increase in the magnitude of the loads that are transmitted through the root portion and into the pitch bearing and hub of the wind turbine, which may, in turn, increase the likelihood of damage occurring to the hub and/or various other components of the wind turbine (e.g., the main rotor shaft of the wind turbine turbine).

Accordingly, a root stiffener assembly that may be used to reduce the occurrence and/or amount of ovalization within the root portion of a rotor blade would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a rotor blade for a wind turbine. The rotor blade may include a body extending between a root end and a tip end. The body may include a root portion extending from the root end. The root portion may include an inner surface defining an inner circumference. In addition, the rotor blade may include a root stiffener assembly disposed within the root portion of the body. The root stiffener assembly may include a plurality of stiffening ribs coupled to the root portion so as to extend along the inner surface. The stiffening ribs may be spaced apart from one another circumferentially around the inner circumference of the root portion.

In another aspect, the present subject matter is directed to a rotor blade for a wind turbine. The rotor blade may include a body extending between a root end and a tip end. The body may include a root portion extending from the root end. The root portion may include an inner surface. In addition, the rotor blade may include a root stiffener assembly disposed within the root portion of the body. The root stiffener assembly may include a plurality of stiffening ribs coupled to the root portion so as to extend along the inner surface. The stiffening ribs may be coupled together around the inner circumference of the root portion so as to form a ring within the root portion.

In a further aspect, the present subject matter is directed to a method for stiffening a root portion of a rotor blade of a wind turbine. The method may generally include coupling a first stiffening rib to the root portion such that the first stiffening rib extends along the inner surface and coupling a second stiffening rib to the root portion such that the second stiffening rib extends along the inner surface. The first and second stiffening ribs may be spaced apart from one another circumferentially around the inner circumference of the root portion.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine;

FIG. 2 illustrates a perspective view of one embodiment of one of the rotor blades of the wind turbine shown in FIG. 1;

FIG. 3 illustrates a perspective view of one embodiment of a root stiffener assembly installed within a root portion of the rotor blade shown in FIG. 2, particularly illustrating the root stiffener assembly include a plurality of stiffening ribs extending around the inner circumference of the root portion;

FIG. 4 illustrates a root end view of the root stiffener assembly shown in FIG. 3;

FIG. 5 illustrates a perspective view of another embodiment of the root stiffener assembly shown in FIG. 3, particularly illustrating the root stiffener assembly including two rows of stiffening ribs extending around the inner circumference of the root portion;

FIG. 6 illustrates a root end view of a further embodiment of the root stiffener assembly shown in FIG. 3, particularly illustrating the root stiffener assembly including a plurality of stiffening ribs interlocked around the inner circumference of the root portion via a plurality of locking ribs;

FIG. 7 illustrates a perspective view of another embodiment of a root stiffener assembly installed within a root portion of the rotor blade shown in FIG. 2, particularly illustrating the root stiffener assembly including a plurality of stiffening ribs interlocked around the inner circumference of the root portion;

FIG. 8 illustrates a root end view of the root stiffener assembly shown in FIG. 7;

FIG. 9 illustrates a root end view of a variation of the root stiffener assembly shown in FIGS. 7 and 8, particularly illustrating the connection joints defined between the stiffening ribs extending in two different directions; and

FIG. 10 illustrates a perspective view of a further embodiment of a root stiffener assembly installed on a root portion of the rotor blade shown in FIG. 2, particularly illustrating the root stiffener assembly including a plurality of stiffening ribs extending around portions of the outer circumference of the root portion.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a root stiffener assembly for a wind turbine rotor blade. Specifically, in several embodiments, the root stiffener assembly may be configured to be installed within the blade root or root portion of a rotor blade in order to increase the stiffness of the root portion, thereby preventing and/or reducing the amount of ovalization occurring within the root portion. As such, the amount of loads transmitted through the root portion and into the pitch bearing and/or hub of the wind turbine may be reduced significantly. Such a reduction in transmitted loads may allow for longer rotor blades to be installed on a wind turbine, which may, in turn, increase the energy capturing capability of the wind turbine.

In several embodiments, the root stiffener assembly may include a plurality of separate stiffening ribs configured to be installed around the inner circumference of the root portion. In general, the stiffening ribs may be configured to be positioned and/or oriented within the root portion and/or relative to one another so as to achieve the desired stiffness characteristics. For instance, in one embodiment, the stiffening ribs may be spaced apart circumferentially around the inner circumference of the root portion and may be axially aligned relative to one another (and relative to the root end of the rotor blade) such that a segmented ring is formed within the root portion.

It should be appreciated that, by configuring the root stiffener assembly to include a plurality of separate stiffening ribs, the root stiffener assembly may be easily and efficiently installed within the rotor blade. For example, the separate stiffening ribs may be significantly lighter in weight than integrally formed stiffening assemblies, thereby making the ribs easier to transport and install uptower. In addition, the lighter ribs may also reduce material and transportation costs.

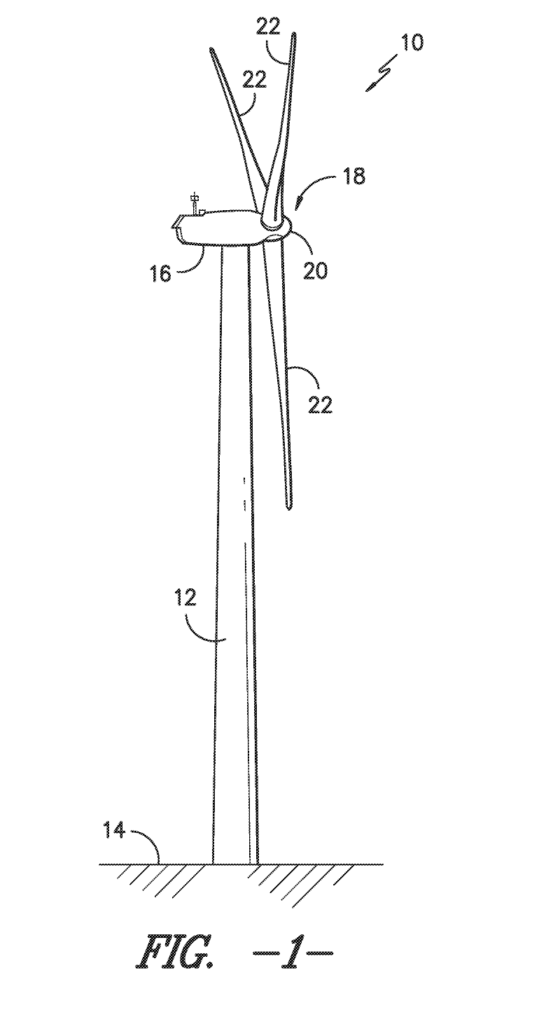

Referring now to the drawings, FIG. 1 illustrates a perspective view of one embodiment of a wind turbine 10. As shown, the wind turbine 10 generally includes a tower 12 extending from a support surface 14, a nacelle 16 mounted on the tower 12, and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or less than three rotor blades 22. Each rotor blade 22 may be spaced about the hub 20 to facilitate rotating the rotor 18 to enable kinetic energy to be transferred from the wind into usable mechanical energy, and subsequently, electrical energy. For instance, the hub 20 may be rotatably coupled to an electric generator (not shown) positioned within the nacelle 16 to permit electrical energy to be produced.

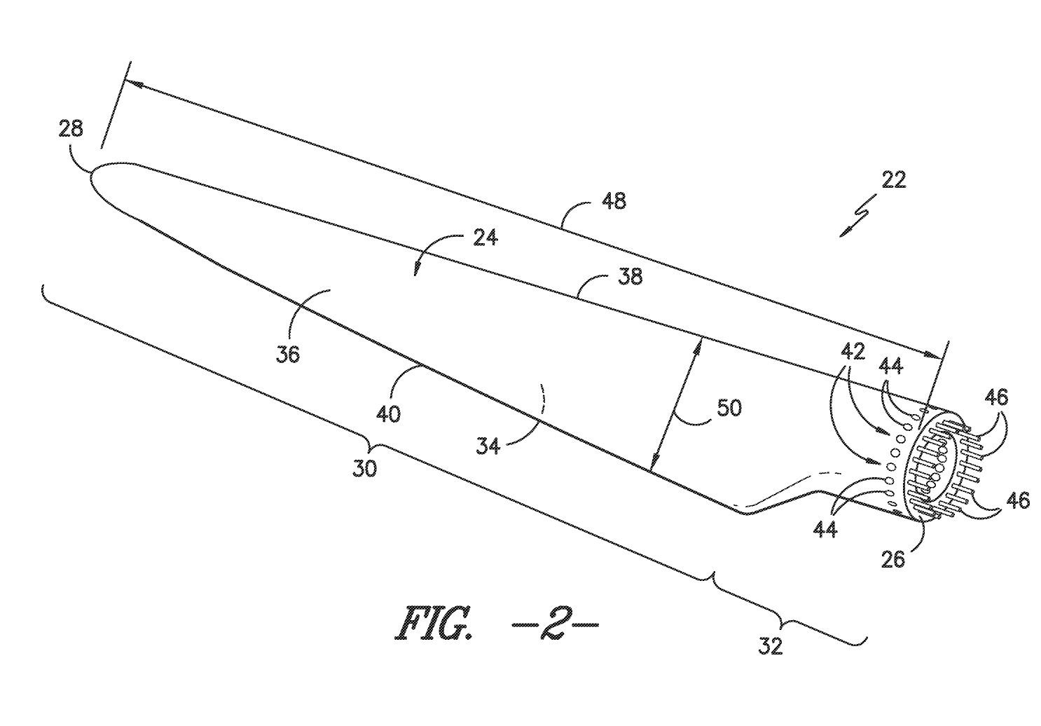

Referring now to FIG. 2, a perspective view of one of the rotor blades 22 shown FIG. 1 is illustrated in accordance with aspects of the present subject matter. As shown, the rotor blade 22 includes a body 24 extending longitudinally between a root end 26 and a tip end 28. The body 24 may generally serve as the outer shell/skin of the rotor blade 22 and may include both an airfoil portion 30 and a root portion 32. As is generally understood, the airfoil portion 30 may extend between the root portion 32 and the tip end 28 of the rotor blade 22 and may generally define an aerodynamic profile (e.g., by defining an airfoil shaped cross-section, such as a symmetrical or cambered airfoil-shaped cross-section) to enable the rotor blade 22 to capture kinetic energy from the wind using known aerodynamic principles. Thus, the airfoil portion 30 may generally include a pressure side 34 and a suction side 36 extending between a leading edge 38 and a trailing edge 40.

Additionally, the root portion 32 may generally be configured to extend between the root end 26 and the airfoil portion 30 of the rotor blade 22. As shown in FIG. 2, at least a portion of the root portion 32 may be configured to define a substantially cylindrical shape. As is generally understood, the root portion 32 may be configured to be mounted or otherwise attached to the wind turbine hub 20 at the root end 26 of the rotor blade 22. Thus, as shown in FIG. 2, the root portion 32 may include a plurality of T-bolts or root attachment assemblies 42 installed therein for coupling the rotor blade 22 to the hub 20. In several embodiments, each root attachment assembly 42 may include a barrel nut 44 mounted within the root portion 32 and a root bolt 46 coupled to and extending from the barrel nut 44 so as to project outwardly from the root end 26. By projecting outwardly from the root end 26, the root bolts 46 may be used to couple the rotor blade 22 to the hub 20 (e.g., via a pitch bearing (not shown)).

Moreover, as shown in FIG. 2, the rotor blade 22 may have a span 48 defining the total length of the blade 22 between its root and tip ends 26, 28 and a chord 50 defining the total length of the blade 22 between the leading edge 38 and the trailing edge 40. As is generally understood, the chord 50 may vary in length with respect to the span 48 as the rotor blade 22 extends from the root end 26 to the tip end 28.

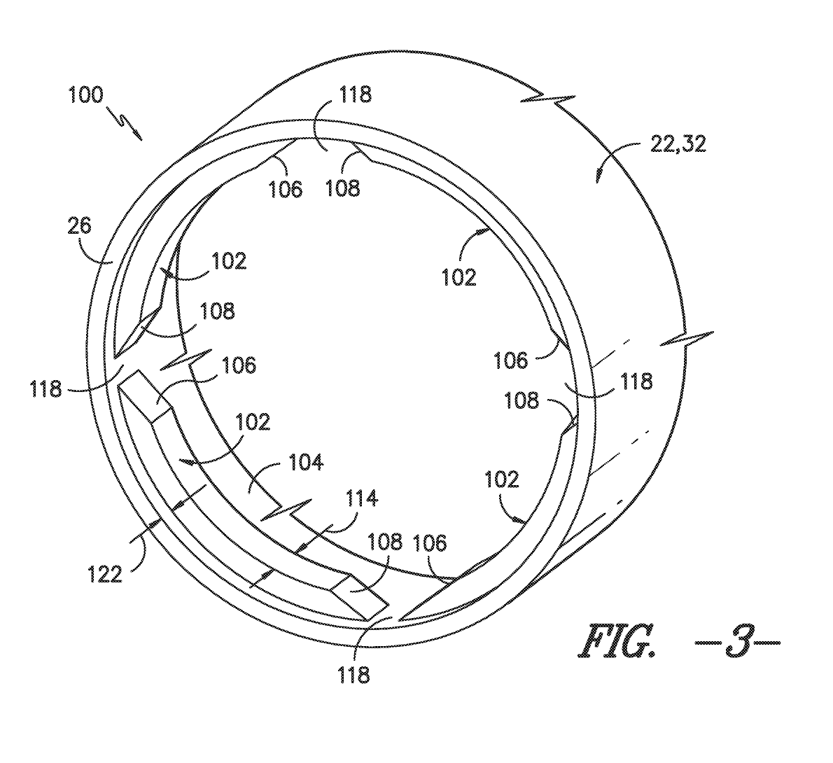

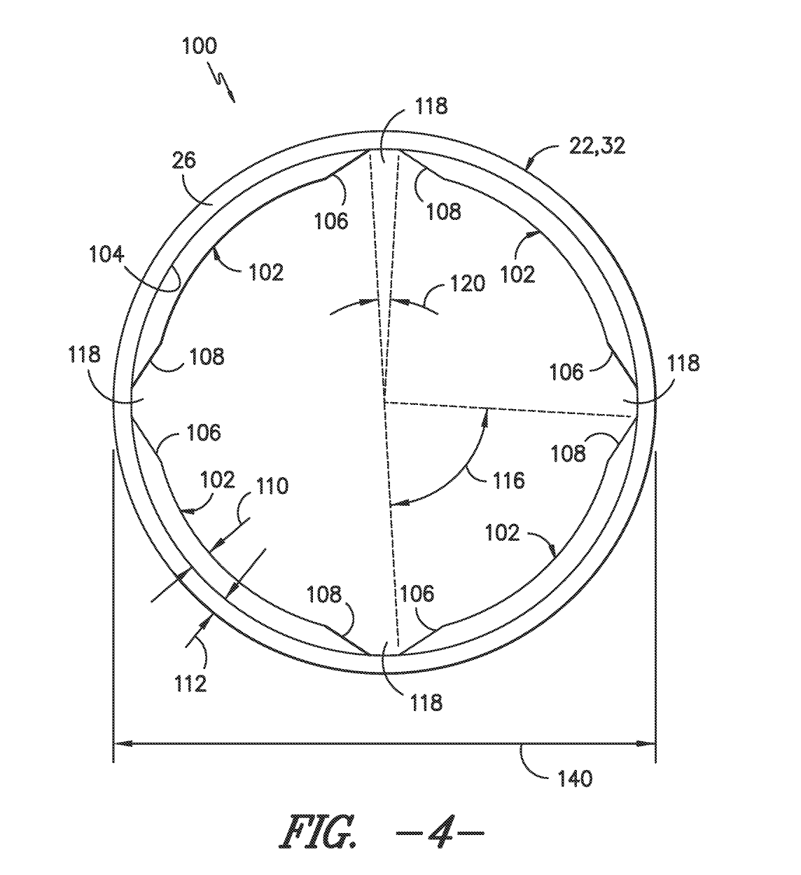

Referring now to FIGS. 3 and 4, one embodiment of a root stiffener assembly 100 suitable for use with the rotor blade 22 described above is illustrated in accordance with aspects of the present subject matter. Specifically, FIG. 3 illustrates a perspective view of the root stiffener assembly 100 installed within the root portion 32 of the rotor blade 22. FIG. 4 illustrates a root end view of the root stiffener assembly 100 shown in FIG. 3.

In general, the root stiffener assembly 100 may be configured to be installed within the root portion 32 of the rotor blade 22. Specifically, in several embodiments, the root stiffener assembly 100 may be configured to extend around all or portions of the inner circumference of the root portion 32. As such, when installed within the rotor blade 22, the root stiffener assembly 100 may generally increase the overall stiffness and/or rigidity of the root portion 32, thereby preventing and/or reducing the amount of ovalization within the root portion 32.

As shown in FIGS. 3 and 4, the root stiffener assembly 100 may include a plurality of stiffening ribs 102 positioned within the root portion 32 so as to extend along portions of an inner surface 104 of the root portion 32. In the illustrated embodiment, the assembly 100 includes four stiffening ribs 102. However, in other embodiments, the assembly 100 may include more than four stiffening ribs 102, such as five or more ribs, or less than four stiffening ribs 102, such as two or three ribs.

In general, each stiffening rib 102 may be configured as an arced or curved structural member extending circumferentially between a first end 106 and second end 108. As shown in the illustrated embodiment, the curvature of each stiffening ribs 102 may generally be selected so as to correspond to the radius of curvature of the inner surface 104 of the root portion 32. Thus, when the stiffening ribs 102 are installed within the rotor blade 22, the ribs 102 may be positioned flush around the inner circumference of the root portion 32.

Additionally, as shown in FIGS. 3 and 4, each stiffening rib 102 may be configured to define a tapered profile at its ends 106, 108 such that a radial thickness 110 (FIG. 4) of the rib 102 is reduced at it extends circumferentially to each end 106, 108. Such tapered ends 106, 108 generally provide the stiffening ribs 102 with increased peal strength, which may prevent the ends 106, 108 from peeling away from the inner surface 104 as the root portion 32 is stressed during operation of the wind turbine 10. However, in other embodiments, the ends 106, 108 of the stiffening ribs 102 may have any other suitable configuration.

Moreover, each stiffening rib 102 may generally have any suitable dimensional configuration that allows it to function as described herein. For instance, in several embodiments, the radial thickness 110 of each rib 102 may range from about 30% to about 100% of a radial thickness 112 of the root portion 32 at the root end 26 of the rotor blade 22, such as from about 40% to about 80% of the radial thickness 112 of the root portion 32 or from about 50% to about 75% of the radial thickness 112 of the root portion 32 and any other subranges therebetween. However, in alternative embodiments, it is foreseeable that the radial thickness 110 of each stiffening rib 120 may be less than about 30% of the radial thickness 112 of the root portion 32 or greater than about 100% of the radial thickness 112 of the root portion 32. In addition, as shown in FIG. 3, each stiffening rib 102 may define an axial width 114. In several embodiments, the axial width 114 of each rib 102 may correspond to a width ranging from about 1% to about 50% of a root diameter 140 (FIG. 4) of the root portion 32, such as from about 2% to about 30% of the root diameter 140 or from about 3% to about 20% of the root diameter 140 and any other subranges therebetween. However, it is foreseeable that, in alternative embodiments, each stiffening rib 102 may define an axial width 114 corresponding to a width that is less than 1% of the root diameter 140 or greater than 50% of the root diameter 140.

Referring still to FIGS. 3 and 4, in several embodiments, the stiffening ribs 102 may be configured to be spaced apart circumferentially from one another around the inner circumference of the root portion 32. For instance, as shown in the illustrated embodiment, each stiffening rib 102 forms an arced segment defining a segment angle 116 that is less than 90 degrees (referenced from the center of the root portion 32). As a result, circumferential gaps 118 are defined between the ends 106, 108 of adjacent stiffening ribs 102. In general, the circumferential spacing between stiffening ribs 102 may be selected such that the gaps 118 define any suitable gap angle 120 between the adjacent stiffening ribs. For instance, in several embodiments, the gap angle 120 may be between 0 degrees and about 45 degrees, such as from about 2 degrees to about 30 degrees or from about 5 degrees to about 15 degrees and any other subranges therebetween.

It should be appreciated that the specific segment angle 116 defined by each stiffening rib 102 may vary depending on the number of ribs 102 installed around the inner circumference of the root portion 32. For instance, for a root stiffener assembly 100 having three stiffening ribs 102, the segment angle 116 defined by each rib 102 may, in one embodiment, be less 120 degrees to allow for circumferential gaps to be defined between the ribs 102.

Additionally, in several embodiments, the stiffening ribs 102 may be configured to be axially aligned within the root portion 32 of the rotor blade 22. For instance, as shown in FIG. 3, each stiffening rib 102 is generally positioned at the same axial distance 122 from the root end 26 of the rotor blade 22. As such, the stiffening ribs 102 form a broken or segmented ring around the inner circumference of the root portion 32. However, in alternative embodiments, the axial distances 122 may be varied so that at least one of the stiffening ribs 102 is axially offset from the other ribs 102.

Moreover, as shown in the illustrated embodiment, the stiffening ribs 102 are generally oriented parallel to the root face or root end 26 of the root portion 32 (e.g., by being oriented at a 90 degree angle relative to the axial or spanwise direction of the rotor blade 22). However, in alternative embodiments, the stiffening ribs 102 may be oriented at any other suitable angle relative to the root end 26 (e.g., by being oriented at an angle less than 90 degrees relative to the spanwise direction). For instance, in one embodiment, each stiffening rib 102 may be oriented at a 45 degree angle relative to the root end 26 (and relative to the spanwise direction) such that the stiffening ribs 102 form a spiral-like shape or pattern within the root portion 32.

It should be appreciated that the stiffening ribs 102 may be generally be formed from any suitable material. For instance, in several embodiments, the ribs 102 may be formed from a relatively stiff material, such as a composite material(s) (e.g., fiber-reinforced composites), metal material(s) (e.g., steel) and/or any other suitable material(s). It should also be appreciated that the stiffening ribs 102 may be configured to be secured within the root portion 32 using any suitable attachment means and/or method known in the art. For instance, in one embodiment, the stiffening ribs 102 may be bonded to the inner surface 104 of the root portion 32 using a suitable adhesive(s). In another embodiment, suitable mechanical fasteners (e.g., bolts, screws, pins, clips, brackets, etc.) may be used to couple each stiffening rib 102 to the root portion 32. Moreover, it should be appreciated that the stiffening ribs 102 may generally be configured to define any suitable cross-sectional shape, such as a rectangular cross-sectional shape, a triangular cross-sectional shape, an “I” beam cross-sectional shape and/or any other suitable shape.

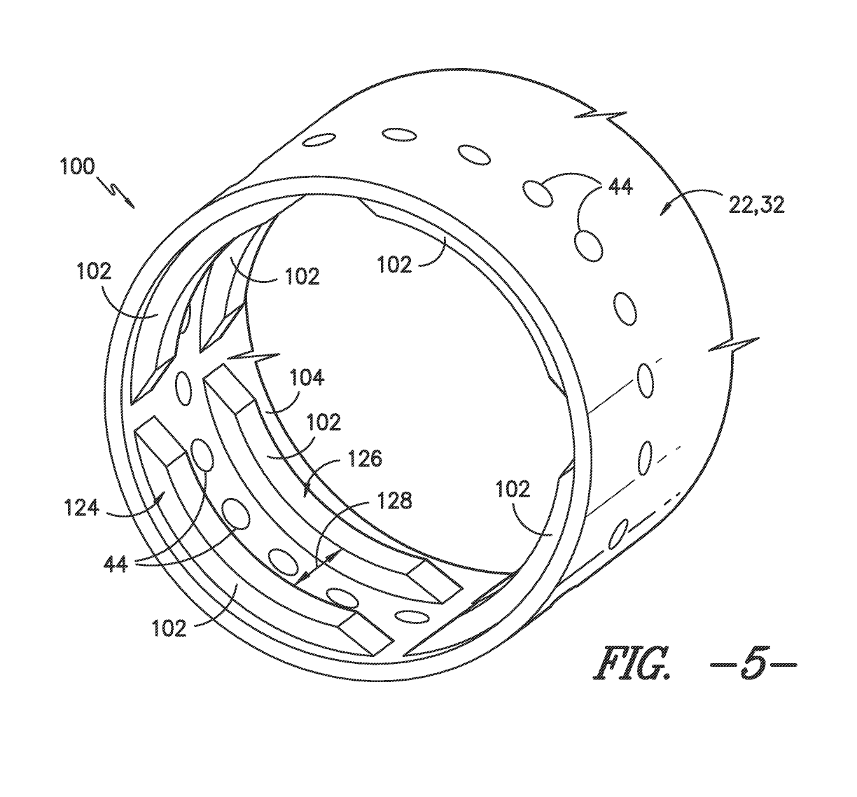

Additionally, as shown in FIG. 3, the root stiffener assembly 100 includes a single row of stiffening ribs 102. However, in alternative embodiments, the root stiffener assembly 100 may include multiple rows of stiffening ribs 102. For example, FIG. 5 illustrates an embodiment in which the root stiffener assembly 100 includes both a first row 124 of stiffening ribs 102 spaced apart circumferentially around the inner circumference of the root portion 32 and a second row 126 of stiffening ribs 102 spaced apart circumferentially around the inner circumference of the root portion 32, with the first and second rows 124, 126 being axially offset by a distance 128. It should be appreciated that, although the embodiment shown in FIG. 4 only includes two rows 124, 126 of stiffening ribs 102, the disclosed root stiffener assembly 100 may generally include any number of rows, such as three or more rows of stiffening ribs 102.

It should also be appreciated that the separate rows 124, 126 of stiffening ribs 102 may generally be positioned at any suitable location within the root portion 32 relative to one another and/or relative to the root end 26 of the rotor blade 22. For instance, as shown in FIG. 4, the stiffening ribs 102 are installed within the root portion 32 such that the first row 124 is located inboard of the barrel nuts 44 of the root attachment assemblies 42 and the second row 126 is located outboard of the barrel nuts 44. However, in alternative embodiments, both the first and second rows 124, 126 may be positioned inboard or outboard of the barrel nuts 44.

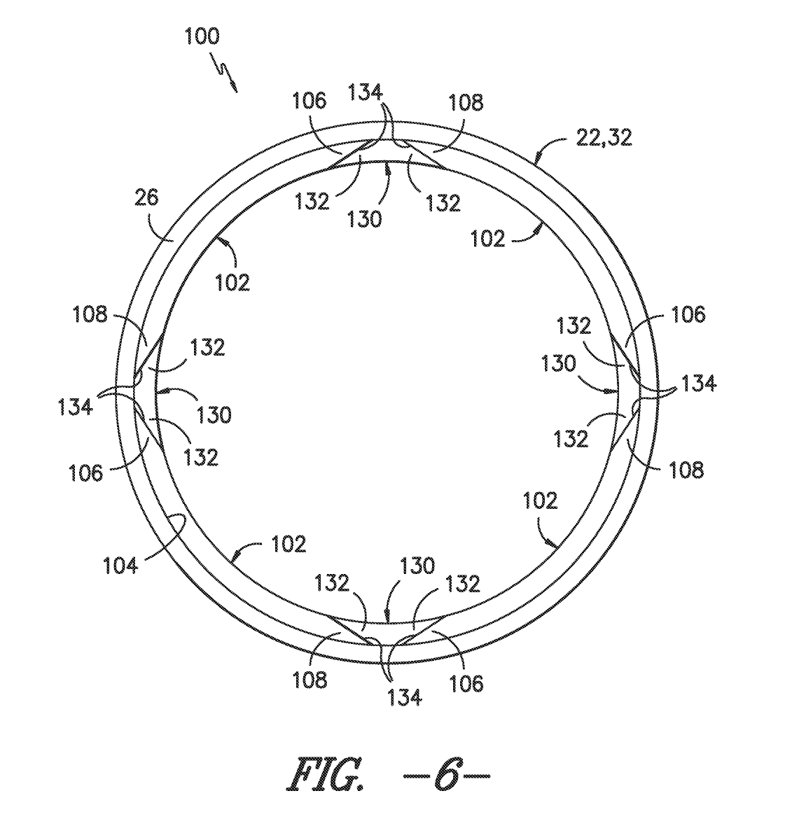

Additionally, in several embodiments, the circumferentially spaced apart stiffening ribs 102 may be configured to be coupled to one another around the inner circumference of the root portion 32 using a plurality of locking ribs 130. For example, FIG. 6 illustrates the root stiffener assembly 100 shown in FIG. 3 having locking ribs 130 installed between the stiffening ribs 102. As shown, each locking rib 130 may be secured between the ends 106, 108 of adjacent stiffening ribs 102 such that the root stiffener assembly 100 defines a complete stiffening ring around the inner circumference of the root portion 32. In such an embodiment, the locking ribs 130 may generally have any suitable configuration that allows such ribs 130 to be secured between the stiffening ribs 102. For instance, as shown in the illustrated embodiment, each locking rib 130 defines tapered ends 132 configured to mate with or otherwise be seated flush against the corresponding tapered ends 106, 108 defined by the stiffening ribs 102. As such, the locking ribs 130 may be secured between the stiffening ribs 102 (e.g., using an adhesive(s) or mechanical fasteners) to form scarf joints 134 at the ends 106, 108 of the stiffening ribs 102.

It should be appreciated that, in several embodiments, the locking ribs 130 may be configured similarly to the stiffening ribs 102. For instance, the locking ribs 130 may have the same or a similar dimensional configuration as the stiffening ribs 102 (e.g., such as by defining the same or a similar radial thickness 110 (FIG. 4) and/or axial width 114 (FIG. 3)) and may be formed from a relatively stiff material(s) (e.g., a composite material(s) and/or a metal material(s)).

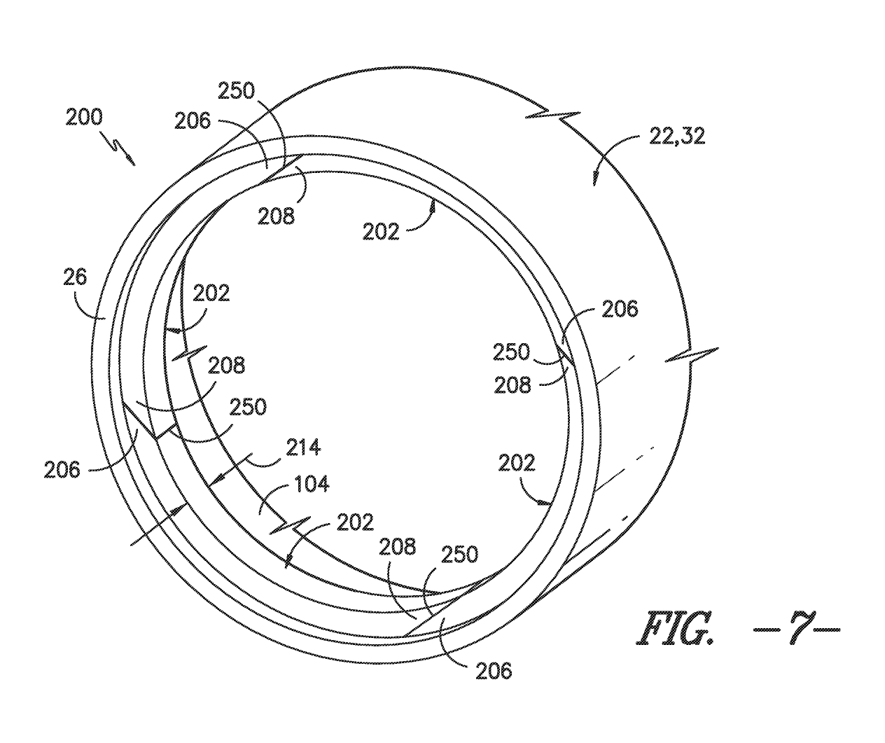

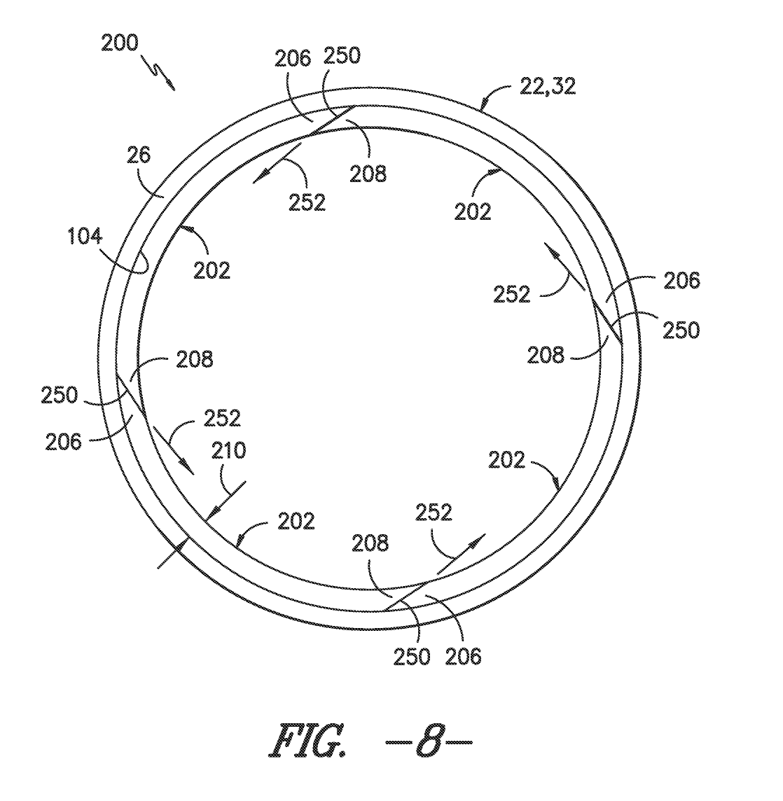

Referring now to FIGS. 7 and 8, another embodiment of a root stiffener assembly 200 suitable for use with the rotor blade 22 described above is illustrated in accordance with aspects of the present subject matter. Specifically, FIG. 7 illustrates a perspective view of the root stiffener assembly 200 installed within the root portion 32 of the rotor blade 22. FIG. 8 illustrates a root end view of the root stiffener assembly 200 shown in FIG. 7.

As shown, the root stiffener 200 may include a plurality of stiffening ribs 202 configured similarly to the stiffening ribs 102 described above. For instance, the stiffening ribs 202 may be configured as arced or curved structural members extending along the inner surface 104 of the root portion 32 between first and second tapered ends 206, 208. Additionally, the stiffening ribs 202 may be configured to define any suitable dimensions, such as any suitable radial thickness 210 (FIG. 8) (e.g., the same or a similar thickness 110 as described above with reference to FIG. 4) and/or axial width 214 (e.g., the same or a similar width 114 as described above with reference to FIG. 3).

However, instead of being spaced apart circumferentially as shown in the embodiments of FIGS. 3-6, the stiffening ribs 202 are configured to be directly coupled to one another around the inner circumference of the root portion 32 so as to form a complete stiffening ring within the root portion 32. Specifically, as shown in FIGS. 7 and 8, the tapered ends 206, 208 of each stiffening rib 202 are configured to interlock or otherwise mate with the tapered ends 206, 208 of adjacent ribs 202 so as to form scarfed connection joints 250 around the inner circumference of the root portion 32. In such an embodiment, the tapered ends 206, 208 of adjacent stiffening ribs 202 may be bonded or otherwise secured together to form the connection joints 250.

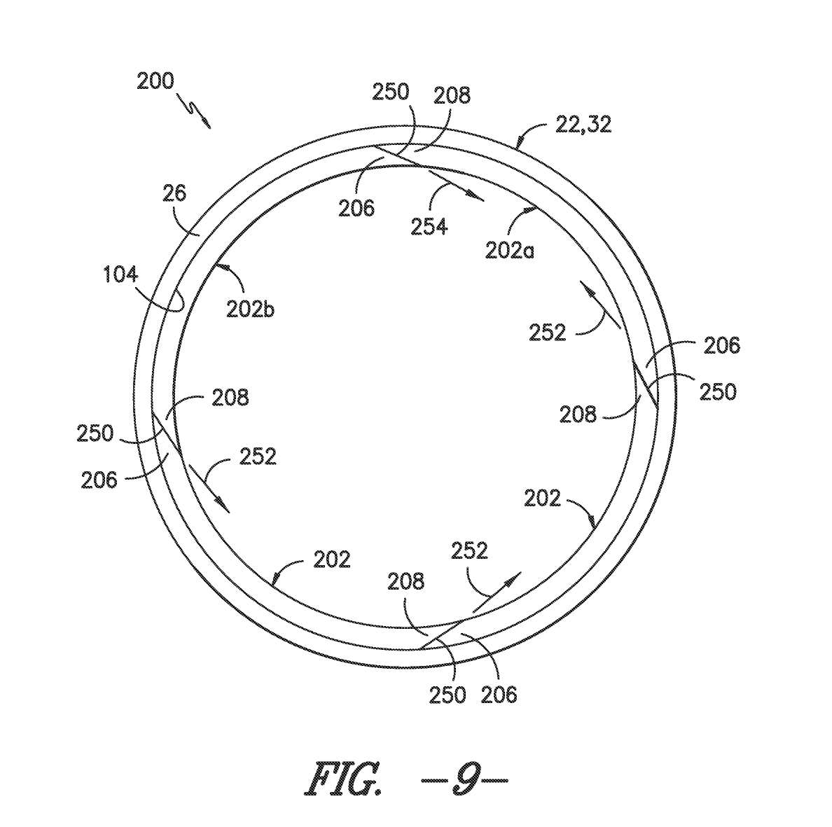

As particularly shown in FIG. 8, in one embodiment, the tapered ends 206, 208 of the stiffening ribs 202 may be configured such that each connection joint 250 extends outwardly in the same joint direction (indicated by arrows 252) relative to the portion of the inner surface 104 defined at each joint 250. However, in other embodiments, the configuration of the tapered ends 206, 208 may be varied to provide for an efficient installation of the stiffening ribs 202 within the root portion 32. For instance, as shown in the alternative embodiment of FIG. 9, the connection joint 250 defined between two of the stiffening ribs 202 (e.g., a first stiffening rib 202a and a second stiffening rib 202b) may be configured to extend in the opposite direction (indicated by arrow 254) than the joint direction (indicated by arrows 252) of the other connection joints 250. As such, when installing the stiffening ribs 202 within the root portion 32, the second stiffening rib 202b may be positioned between its adjacent stiffening ribs 202 by simply moving the stiffening rib 202b radially outwardly towards the inner surface 104 of the root portion 32 (as opposed to having to slide the rib 202b axially into place).

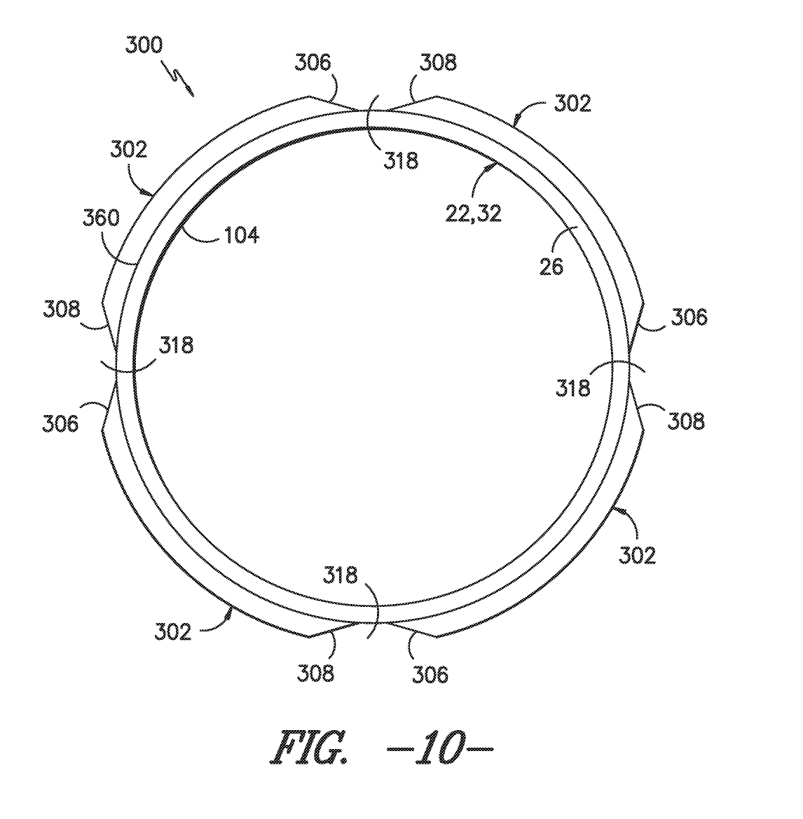

Referring now to FIG. 10, a further embodiment of a root stiffener assembly 300 suitable for use with the rotor blade 22 described above is illustrated in accordance with aspects of the present subject matter. As shown, the root stiffener assembly 300 may include a plurality of stiffening ribs 302 configured the same as or similar to the stiffening ribs 102, 302 described above. For instance, the stiffening ribs 302 may be configured as arced or curved structural members extending along between first and second tapered ends 306, 308. Additionally, the stiffening ribs 302 may be configured to define any suitable dimensions, such as any suitable radial thickness (e.g., the same or a similar thickness 110 as described above with reference to FIG. 4) and/or axial width (e.g., the same or a similar width 114 as described above with reference to FIG. 3).

However, unlike the embodiments described above with reference to FIGS. 3-9, the stiffening ribs 302 may be configured to extend along an outer surface 360 of the root portion 32 so as to define a segmented or complete ring around the outer circumference of the root portion 32. When installing the stiffening ribs 102 along the outer surface 360, the ribs 302 may, in several embodiments, be configured to be spaced apart circumferentially from one another around the outer circumference of the root portion 32. For instance, as shown in FIG. 10, the stiffening ribs 302 may be spaced apart so as to define circumferential gaps 318 between each adjacent pair of the ribs 302 (e.g., similar to the embodiment shown in FIGS. 3 and 4). In another embodiment, locking ribs (now shown) may be coupled between the stiffening ribs 302 so that the root stiffener assembly 300 forms a complete ring around the outer circumference of the root portion 32 (e.g., similar to the embodiment shown in FIG. 6). Alternatively, similar to the embodiments shown in FIGS. 8 and 9, the stiffening ribs 302 may be configured to be directly coupled to one another around the outer circumference of the root portion 32.

As indicated above, the present subject matter is also directed to a method for stiffening a root portion 32 of a rotor blade 22 of a wind turbine 10. For example, in several embodiments, the method may generally include coupling one or more stiffening ribs to the root portion 32 such that the stiffening ribs extend along the inner surface 104 of the root portion 32. In doing so, the stiffening ribs may be positioned and/or oriented within the root portion 32 and/or relative to one another in any suitable manner that provides the desired stiffness characteristics for the root portion 32. For instance, in several embodiments, the stiffening ribs may be installed within the root portion 32 so as to be axially aligned with one another, thereby forming a segmented ring within the root portion 32.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A rotor blade for a wind turbine, the rotor blade comprising:
a body extending between a root end and a tip end, the body including a root portion extending from the root end, the root portion including an inner surface defining an inner circumference;
a root stiffener assembly disposed within the root portion of the body, the root stiffener assembly including a plurality of stiffening ribs coupled to the root portion so as to extend along the inner surface, the stiffening ribs being spaced apart from one another circumferentially around the inner circumference of the root portion.

2. The rotor blade of claim 1, wherein each stiffening rib extends between a first tapered end and a second tapered end.

3. The rotor blade of claim 1, wherein the plurality of stiffening ribs comprises a first row of stiffening ribs spaced apart circumferentially around the inner circumference of the root portion and a second row of stiffening ribs spaced apart circumferentially around the inner circumference of the root portion, the first row of stiffening ribs being spaced apart axially from the second row of stiffening ribs.

4. The rotor blade of claim 1, wherein each stiffening rib defines a radial thickness ranging from about 30% to about 100% of a radial thickness of the root portion.

5. The rotor blade of claim 1, wherein each stiffening rib defines an axial width corresponding to a width ranging from about 2% to about 30% of a root diameter of the root portion.

6. The rotor blade of claim 1, wherein a circumferential gap is defined along the inner surface between each pair of adjacent stiffening ribs, each circumferential gap defining a gap angle between 0 degrees and 45 degrees.

7. The rotor blade of claim 1, further comprising a plurality of locking ribs extending along the inner surface of the root portion, each locking rib being coupled between a pair of adjacent stiffening ribs.

8. The rotor blade of claim 7, wherein each locking rib defines tapered ends configured to engage corresponding tapered ends of the adjacent stiffening ribs.

9. The rotor blade of claim 7, wherein the plurality of stiffening ribs and the plurality of locking ribs are interlocked around the inner circumference of the root portion so as to define form a ring within the root portion.

10. The rotor blade of claim 1, wherein the plurality of stiffening ribs comprises four stiffening ribs spaced apart circumferentially around the inner circumference of the root portion.

11. A rotor blade for a wind turbine, the rotor blade comprising:
a body extending between a root end and a tip end, the body including a root portion extending from the root end, the root portion including an inner surface defining an inner circumference;
a root stiffener assembly disposed within the root portion of the body, the root stiffener assembly including a plurality of stiffening ribs coupled to the root portion so as to extend along the inner surface, the stiffening ribs being coupled together around the inner circumference of the root portion so as to form a ring within the root portion.

12. The rotor blade of claim 11, wherein each stiffening rib defines tapered ends, the tapered ends of adjacent stiffening ribs being configured to engage one another so as to define a plurality of connection joints around the inner circumference of the root portion.

13. The rotor blade of claim 11, wherein at least one of the plurality of connection joints defines a joint direction relative to the inner surface that differs from a joint direction of the remainder of the plurality of connection joints.

14. The rotor blade of claim 11, wherein the plurality of stiffening ribs are spaced apart from one another circumferentially around the inner circumference of the root portion, the plurality of stiffening ribs being coupled together around the inner circumference of the root portion via a plurality of locking ribs extending along the inner surface of the root portion, each locking rib being disposed between a pair of adjacent stiffening ribs.

15. The rotor blade of claim 14, wherein each locking rib defines tapered ends configured to engage corresponding tapered ends of the adjacent stiffening ribs.

16. The rotor blade of claim 11, wherein each stiffening rib defines a radial thickness ranging from about 30% to about 100% of a radial thickness of the root portion.

17. The rotor blade of claim 11, wherein each stiffening rib defines an axial width corresponding to a width ranging from about 2% to about 30% of a root diameter of the root portion.

18. A method for stiffening a root portion of a rotor blade of a wind turbine, the root portion including an inner surface defining an inner circumference, the method comprising:
coupling a first stiffening rib to the root portion such that the first stiffening rib extends along the inner surface;
coupling a second stiffening rib to the root portion such that the second stiffening rib extends along the inner surface,
wherein the first and second stiffening ribs are spaced apart from one another circumferentially around the inner circumference of the root portion.

19. The method of claim 18, further comprising axially aligning the first and second stiffening ribs within the root portion such that the first and second stiffening ribs form a segmented ring around the inner circumference of the root portion.

20. The method of claim 18, wherein each of the first and second stiffening ribs extends between a first tapered end and a second tapered end.
